(19) United States
(12) Patent Application Publication
(10) Pub. No.: US 2013/0077535 A1
(43) Pub. Date: Mar. 28, 2013

(54) Connection of Telephone Calls

(71) Applicant: Alexander David Redston, Norfolk (GB)

(72) Inventor: Alexander David Redston, Norfolk (GB)

(73) Assignee: SWITCH RESEARCH LIMITED, Oxfordshire (GB)

(21) Appl. No.: 13/251,312

(22) Filed: Oct. 3, 2011

(30) Foreign Application Priority Data
Sep. 27, 2011 (GB) 1116614.7

(51) Int. Cl. H04L 12/16

(52) U.S. Cl. 370/259

(57) ABSTRACT

A method of connecting a telephone call from a called party to a caller attempting to place an initial call to the called party comprises the steps of identifying an incoming call as originating from the called party using contact information stored in a device of the caller (4), dropping the initial call, and automatically connecting the call from the called party (5). Apparatus for carrying out the method may comprise a mobile telephone, a PABX switchboard, an item of Voice Over IP (VOIP) hardware, a device such as a computer, phone or tablet programmed with VOIP software, or an item of telephone exchange equipment.

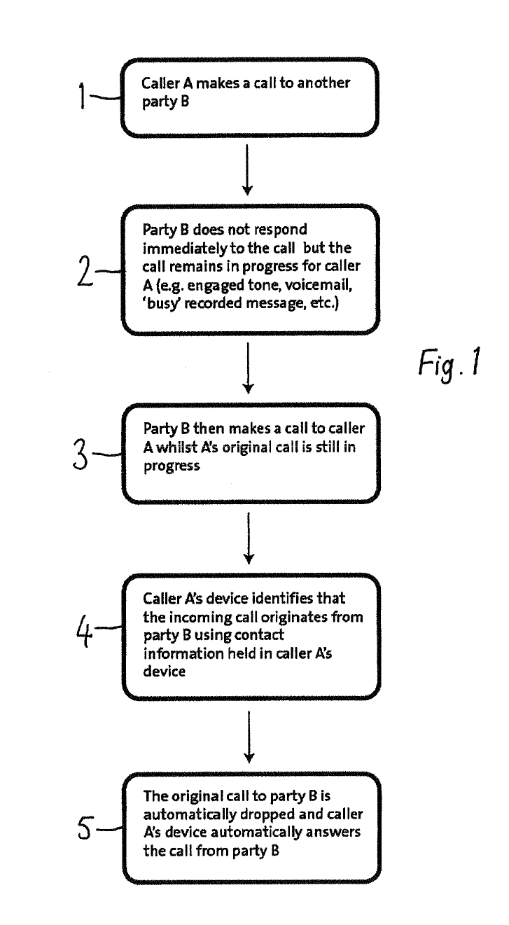

### BACKGROUND TO THE INVENTION

This invention relates to a method and apparatus for connecting a telephone call to a called party already attempting to call the caller.

It is common for mobile phone users to miss calls from each other. If the called party does not immediately answer, the caller may hear an engaged tone, or a message stating that the called party is unavailable, which may prompt the caller to leave a voicemail message.

The called party may see the caller's telephone number any may attempt to place a call to the caller. However if the caller's initial call is still in progress—for example, if the caller is in the process of leaving a voicemail message, this return call will not reach the caller. Users become frustrated as each reaches the other's voicemail facility.

Call waiting is only a partial solution to this problem. Typically the first caller is alerted to the incoming call and must acknowledge that the call is coming from the person he or she is calling, and decide whether to accept, reject or ignore the incoming call or place it on hold.

### SUMMARY OF THE INVENTION

The invention provides a method of connecting a telephone call from a called party to a caller attempting to place an initial call to the called party, comprising the steps of identifying an incoming call as originating from the called party using contact information stored in a device of the caller, dropping the initial call, and automatically connecting the call from the called party.

Prior to the automatic connection step, the caller and/or called party may be alerted that the call is about to be connected. The alert may be an audible or visual alert.

The contact information may consist of a telephone number dialled in the initial call and from which the call from the called party originates. Additionally, the contact information may include a number different from the telephone number from which the call from the called party originates, but known to be a telephone number of the called party. The method may include recognising the number of a call from a called party in international format where the contact information is in local format and/or vice versa.

The invention also provides apparatus for connecting a telephone call from a called party to a caller attempting to place an initial call to the called party, the apparatus being configured to identifying an incoming call as originating from the called party using contact information stored in the apparatus, and to drop the initial call, and automatically connect the call from the called party.

The apparatus may comprise a mobile telephone, a PABX switchboard, an item of telephone exchange equipment, an item of Voice Over IP hardware, or a device programmed with Voice Over IP software.

### BRIEF DESCRIPTION OF THE DRAWING

The invention will now be described in more detail, by way of example only, with reference to the accompanying drawing, the single FIGURE of which is a flowchart showing an embodiment of the method according to the invention.

### DETAILED DESCRIPTION OF PARTICULAR EMBODIMENTS

In the drawing, step 1 shows how caller A makes a call to party B. In step 2, party B does not immediately respond to the call but the call remains in progress, and caller A hears an engaged tone or a recorded message, and may start to record a voicemail message.

In step 3, part B makes a call to caller A whilst A's original call is still in progress. In step 4, A's device, which has Caller ID and Call Waiting services in place, identifies the call from B as being from the very party A is already calling. This can be simply by matching the numbers of the incoming and outgoing calls.

It may also be that the numbers do not match but the device is configured, in an option, to use stored information to identify the number of the incoming call as being another number belonging to B. The device may be capable of recognising the same number in a different format, e.g. in international format when a party's number is stored in the device in local format or vice versa.

In step 5, A's device drops the original, outgoing call and answers the call from party B. Prior to doing so, the caller A and/or the party B may be alerted that the call is about to be connected. The alert may be an audible or visual alert. Any audible alert is made brief, for example the word “hello” or a simple beep, to avoid confusion with a conventional recorded message, e.g. prompting voicemail.

In the event that an incoming call is received from a party other than that originally dialled then the normal call waiting behaviour of the device is activated.

The device may be configurable to exclude certain numbers from being answered according to the method of the invention.

The device may comprise a mobile telephone, a PABX switchboard, an item of Voice Over IP (VOIP) hardware or a device such as a computer, phone or tablet programmed with VOIP software. It may also comprise an item of telephone exchange equipment, the contact information being ascertained from the original call.

What is claimed is:

1. A method of connecting a telephone call from a called party to a caller attempting to place an initial call to the called party, comprising the steps of identifying an incoming call as originating from the called party using contact information stored in a device of the caller, dropping the initial call, and automatically connecting the call from the called party.

2. A method according to claim 1, wherein, prior to the automatic connection step, an alert is provided to the caller.

3. A method according to claim 1, wherein, prior to the automatic connection step, an alert is provided to the called party.

4. A method according to claim 2, wherein the alert comprises an audible alert.

5. A method according to claim 2, wherein the alert comprise a visual alert.

6. A method according to claim 1, wherein the contact information comprises a telephone number dialled in the initial call and from which the call from the called party originates.

7. A method according to claim 1, wherein the contact information comprises a number different from the telephone number from which the call from the called party originates, but known to be a telephone number of the called party.

8. A method according to claim 1, including recognising the number of a call from a called party in a different format from a format in which said number is provided in the contact information.

9. Apparatus for connecting a telephone call from a called party to a caller attempting to place an initial call to the called party, the apparatus being configured to identifying an incoming call as originating from the called party using contact information stored in the apparatus, and to drop the initial call, and automatically connect the call from the called party.

10. Apparatus according to claim 9, wherein the contact information comprises a telephone number dialled in the initial call and from which the call from the called party originates.

11. Apparatus according to claim 9, wherein the contact information comprises a number different from the telephone number from which the call from the called party originates, but known to be a telephone number of the called party.

12. Apparatus according to claim 9, configured to recognise the number of a call from a called party in a different format from a format in which said number is provided in the contact information.

13. Apparatus according to claim 9, comprising a mobile telephone.

14. Apparatus according to claim 9, comprising a PABX switchboard.

15. Apparatus according to claim 9, comprising an item of telephone exchange equipment.

15. Apparatus according to claim 9, comprising an item of Voice Over IP hardware.

16. Apparatus according to claim 9, comprising a device programmed with Voice Over IP software.
